(19) United States
(12) Patent Application Publication
(10) Pub. No.: US 2017/0316463 A1
(43) Pub. Date: Nov. 2, 2017

(54) Method, Apparatus and System for Monitoring Attention Level of a User of a Communications Device

(71) Applicant: Telefonica Digital Espana, S.L.U., Madrid (ES)

(72) Inventors: Martin Pielot, Madrid (ES); Nuria Oliver Ramirez, Madrid (ES); Tilman Dingler, Madrid (ES)

(21) Appl. No.: 15/142,349

(22) Filed: Apr. 29, 2016

(51) Int. Cl. G06Q 30/02; H04W 88/02; H04W 24/08

(52) U.S. Cl. CPC G06Q 30/0269; G06Q 30/0267; H04W 88/02; H04W 24/08

(57) ABSTRACT

A method, device and system for the determination of the attention level of an user of a communication device. The proposed invention detects situations when users are more likely to pay attention to content presented to it (e.g. when they combat boredom) or in other words, situations when users are more receptive to content, without requiring the user to perform certain specific activities or requiring any interventions or specific sensors. In order to do so, user data such as demographics, user context, and usage patterns of the user's communication device (e.g. a mobile phone) is collected.

### FIELD OF THE INVENTION

The present invention relates to detection of user's attention state and more specifically to the determination of the attention level of an user of a communication device to content presented to him or in other words, the determination of the receptivity level of an user of a communication device to new content presented to him.

### BACKGROUND OF THE INVENTION

Human attention has become a scarce resource. In today's connected world, people are constantly exposed to external stimulation through technology (e.g. through connected TVs and desktop PCs at home or through tablets or mobile phones on the go), so an increasing number or services is requesting our attention. Thus, pushing content, information, or recommendations to the user can fail because the user simply cannot or does not want to pay attention to it. Knowing when a user is likely to pay attention to a specific piece of content is becoming increasingly valuable.

At the same time, one frequently occurring affective state goes along with an abundance of resources requesting our attention: Boredom. That is, people habituate to this constant exposure of stimuli to the point that, when the level of stimulation drops, they become bored and find it difficult to deal with the situation. Historically, boredom is defined as displeasure caused by “lack of stimulation or inability to be stimulated thereto. “A bored person is not just someone who does not have anything to do; it's someone who is actively looking for stimulation but it is unable to do so”. In these situations, people often seek stimulation, and often from their mobile phones or other similar devices (e.g. tablets). These devices are a commonly used tool to fill or kill time when bored.

Given that attention is scarce, this offers a valuable opportunity: detecting instances when people seek ways out of boredom (a state where people is more receptive to pay attention to content presented to them) by killing time on their mobile. There is a need for tools which automatically detect patterns of human behavior related to states (e.g. boredom) when a user is likely to pay attention to content presented to them which would allow for a variety for improved services, including context-aware services, proactive recommendations, or appropriate nudges to use the boredom state for introspection.

There are a number of solutions related to detecting affective states. The most popular methods for detecting affective states, which include boredom, have been facial expressions (a known solution propose training a mobile phone front camera to predict emotional expressions on user's face), speech and its paralinguistic features, text, and physiological signals. Other solutions propose detecting boredom from the nature of the keystrokes on a computer keyboard during a writing task (keystrokes were able to predict boredom with roughly 11% above chance when discriminating between engagement and boredom) or predict openness of a person, who is doing web search, to let themselves be distracted from their main task, using mouse movements, clicks, page scrolls, and other fine-grained interaction events.

Some social platforms are explicitly (e.g. BuzzFeed) or implicitly (e.g. Facebook) designed to be used during phases of boredom, so people use such services basically to pass the time. Hence, ads appearing on these platforms make use of an implicit likelihood that boredom drove the user to visit the web page.”

There are also some patents which propose method to somehow detect affective states. For example, U.S. Pat. No. 8,700,009 B2 describes a method and apparatus for monitoring emotion in an interactive network. It claims a method that requires downloading an application to a mobile phone from an Internet server, with the application being configured to receive a physiological signal from a biosensor. US 20080221401 A1 protects the identification of emotional states using physiological responses by exposing a person to a stimulus, measuring the person's physiological responses, comparing this measurement to a baseline, and determining the emotion. U.S. Pat. No. 7,982,620 B2 proposes a system and method for reducing boredom while driving. Boredom is derived from vehicle operation data (e.g. throttle position, cruise control, steering wheel activity), a driver monitor (e.g. microphone, motion sensor, driver position), as well as GPS and a vehicle sensor. Finally, US 20130151333 A1 discloses the idea of affect-based evaluation of advertisement effectiveness by collecting affective feedback of a multitude of people while they are exposed a commercial. Feedback is primarily collected by observing facial expressions via camera, then, an algorithm predicts the general effectiveness of this advertisement on the basis of the obtained feedback.

However, none of the existing prior art solve the problem of automatic detection of patterns of human behavior related to states when a user is likely to pay attention (e.g. boredom), as the present invention does.

Moreover, the existing solutions for detecting affective states present some problems: Some of the approaches described in prior art requires wearing, adjusting, or preparing dedicated sensors. This mainly includes physiological sensors to measure emotion-related body-activity, such as triode electro-myograms measuring facial muscle tensions, photoplethysmyograph measuring blood volume pressure, skin conductance sensor measuring electrodermal activity, respiration sensors . . . . All these sensors are expensive and cumbersome to wear, calibrate, maintain (they may run out of battery) and will therefore rarely been found used by a majority of people during the day.

The rest of approaches described in prior art requires the user performing certain activities such as looking into a stationary camera or in the front-facing camera of the mobile phone, entering text through the keyboard of a desktop computer, speaking near a microphone, using certain service, drive a car, doing web search on a stationary computer . . . . These solutions will not work outside their target activity. For example, they would miss those frequent events where people use their mobile phones to combat boredom.

In other words, all these approaches limit the application of the respective inventions to certain use cases, where users are performing certain tasks, and where wearing sensors is either required or beneficial and desired by the user. However, as state a lack of stimulation (when a user is likely to pay attention) may frequently occur outside these situations, which means that they may go undetected by these methods. Moreover, all these sensors are expensive and cumbersome to wear, calibrate and maintain.

Therefore, there is a need for an optimized and more proactive solution with does not present the aforementioned problems of the prior art. A solution is needed, which detects states when a user is receptive to contents (likely to pay attention, e.g. boredom), allowing to determine when to interact with a user on the basis of her or his receptivity state, also called attention state (so the content of the interaction is more likely to be assimilated and taken into account by the user), without requiring the user to perform certain specific activities for the detection, or to wear any expensive and cumbersome sensors.

### SUMMARY OF THE INVENTION

The problems found in prior art techniques are generally solved or circumvented, and technical advantages are generally achieved, by the disclosed embodiments which provide a method, apparatus and system for the determination of the attention state (also called attention level or receptivity level) of an user of a communication device and more specifically for the detection of user states when the user is receptive to content presented to him (e.g. boredom).

The present invention detects situations when users are more likely to pay attention to content presented to them (e.g. when they combat boredom) or in other words, situations when users are more receptive to content. In order to do so, user data such as demographics, user context, and usage information (e.g. usage patterns) of an user's communication device (e.g. a mobile phone) is collected. This data is fused and automatically sense is made out of this data to determine the attention state of the user (for example, by an intelligent component which recognizes usage patterns that are likely to go along with the user is likely to be receptive to new content). Moreover, the proposed method, apparatus and system can be configured to trigger external services when it is detected that the user is likely to pay attention to information presented to him. Optionally, the ground truth may be established, using a further component that allows the intelligent component to learn, when the user actually feels bored. The term “ground truth” refers to the process of gathering the proper objective data for the learning process. This invention takes advantage of the fact that when a user is presented with suggested content, he is statistically significantly more likely to pay attention to it and to engage with it when he is bored.

It is important to point out that the proposed invention achieves his objective (estimating situations when users are more likely to pay attention to content presented to it), without requiring the user to perform certain specific activities for said estimation or requiring any interventions or any specific sensor for said estimation, saving therefore time and resources.

In a first aspect, it is proposed a method for monitoring attention level of a user of a communications device, the method comprising the following steps:
an electronic device obtaining information about the usage of the communications device by the user (communications device usage information) and the usage context (during a time window of a certain duration);
the electronic device determining, using a computer based technique (for example a machine-learning technique), the attention level of the user based at least on obtained information about the usage of the communications device by the user (during the time window) and about the usage context;
if the electronic device determines that the attention level of the user is above a certain threshold, the electronic device transmitting through a communications network a notification (for example, a notification message or more generally speaking a signal or message which contains for example information about the determined attention level or information to trigger a certain service. For example, said notification may be sent to at least one external service provider).

The electronic device (electronic module) may obtain as well information of the user (information of the user profile) and the attention level of the user may be determined based also on said user profile information obtained.

In an embodiment, the electronic device transmits through the communications network, a notification including the determined attention level to one or more external service providers in any case, even the attention level of the user is below the certain threshold.

The notification may be sent to at least one external service provider and said notification may trigger that the external service provider provides a certain service to the user through a communications device of the user (through the communications device previously mentioned or through other communications device of the user). For example, it may trigger that the service provider provides certain communications content to the user. The triggered service may depend on the determined attention level of the user.

The electronic device may be part of the communications device or may be for example, a server external to the communications device, the communications device being communicated with the server through a communications network (the same communications network used by the electronic device to send the notification or a different communications network).

The communications device may be a mobile device such as a mobile phone or any other type of user's communications device.

In an embodiment the method further comprises:
the electronic device obtaining ground-truth information about the previous attention level of the user (that is, the attention level of the user in one or more time windows previous to the time window to which the communications device usage information belongs); the attention level of the user may be determined based also on this ground information obtained.

In this case, the determining step may include:
using a machine-learning model (or more generally speaking a computer based model) of the level of attention of the user for determining the level of attention, based on obtained information about usage of the communications device and optionally on information of the user;
wherein the model has been trained and updated using ground truth information and information about usage of the communications device (and optionally information of the user and usage context) obtained in previous time windows (time windows previous to the time window to which the usage information belongs).

The ground truth may be established by sending periodically a message to the communications device of the user, through a communications network (the same communications network used by the electronic device to send the notification or a different communications network), asking to the user (through the user interface of the communications device) about his current attention level (the user answers to the question through the user interface of the communications device). The ground truth may be also established by transmitting through the communications network, media content to the user (through an user interface of the communications device) and recording whether the user interacts with the content or not; or by measuring the time between the recommendation of a media content to the user and the user accessing this media content; or by measuring the time that the user spent interacting with recommended media content.

The usage context information is information of the context of the obtained communications device usage information, said context information may include: day of the week, time (hour) of the day, location of the user, ambient noise or light level (all these parameters referred to the time window which the communications device usage information belongs to) or any other type of context information. The user's information (user profile information) may comprise for example: age of the user, gender of the user (and other demographical data of the user), personality traits of the user, estimation of physical activity of the user (this can be done, for example, by detecting the current form of locomotion of the user: walking driving, seating . . . , or by using a movement detector or an step detector) or any other type of user's information.

The communications device usage information may include one or more of the following type of information: previous attention level, recent usage intensity of the communications device and, generally speaking, it may include usage patterns of the communications device by the user in a certain (usually recent) time window, as for example: number of notifications to the user trough the communications device in the time window, number of unlocks of the communications device in the time window, number of applications opened by the user in the communications device in the time window, last application used in the time window, data throughput within said predefined time window, category of most used applications apps in the communications device by the user, time spent in communications applications by the user in the communications device or any other type of usage information.

The communications device usage information may be stored in a node of the communications network infrastructure. The communications device usage information may be recorded for billing purposes by communications provider and said information may include: Call data records, Network events, Location, Demographic data of the user and Personality data derived from typical call behavior

The external service provider to which the notification is sent may be an advertisement service provider, where the notification includes information about the determined attention level of the user and where the method further includes:
the advertisement service provider sending advertisement content to the communications device of the user depending on the determined attention level of the user received (for example only sends advertisement content if the attention level of the user is above a certain minimum level) and/or
the advertisement service provider may charge (put higher prices) to the advertised companies for sending his advertisement contents to the user depending on the determined attention level of the user received, that is, when the determined attention level of the user is higher than a certain minimum level (this certain minimum level may be equal to the certain threshold or not).

The computer-based technique may use a computer-based model that matches usage information and user's information with levels of attention; wherein the model has been trained and updated using at least usage information and user's information obtained in previous time windows (time intervals). The computer-based technique may be a machine-learning technique, for example: Bayesian Networks, Linear Regression, Support Vector Machines, Decision Trees or Hidden Markov Models or any other.

In another aspect, it is proposed an electronic device (also called electronic module) for monitoring attention level of a user of a communications device, the electronic device comprising:
an event-logger module for obtaining information about the usage of the communications device by the user (communications device usage information) and usage context (during a time window);
an estimation module for determining, using a computer based technique (for example a machine learning technique), the attention level of the user based at least on the information obtained by the event-logger module
a communications module for transmitting through a communications network a notification (to at least one external service provider). This may be done, for example, only if it is determined that the attention level of the user is above a certain threshold.

The electronic device may further comprise:
an user characteristic database storing information of the user (user profile information) and where the attention level of the user is determined by the estimation module based as well on the user profile information stored by the user characteristic database.

The electronic device may further comprise:
an interactive module for obtaining ground-truth information about previous attention level of the user and where the attention level of the user is determined by the estimation module based as well on the ground-truth information obtained by the interactive module.

The electronic device may be the communications device (e.g. a mobile phone) or may be a network server.

In another aspect, it is proposed a system for monitoring attention level of a user of a communications device, the electronic device comprising:
the communications device of the user for providing communications service to the user through a communications network.
an electronic device comprising:
an event-logger module for obtaining information about the usage of the communications device by the user (communications device usage information) and usage context (during a time window);
an estimation module for determining, using a computer based technique (for example a machine learning technique), the attention level of the user based at least on the information obtained by the event-logger module
a communications module for transmitting through a communications network (through the same network used by the communications device to provide a communications service to the user or through a different communications network), a notification (to at least one external service provider, if it is determined that the attention level of the user is above a certain threshold).

In another aspect of the present invention, a non-transitory computer readable (storage) medium is disclosed comprising instructions for causing a computer device to perform the step of the above-described method.

Consequently, according to the invention, a method, apparatus, system, and non-transitory computer readable medium according to the independent claims are provided. Favourable embodiments are defined in the dependent claims. These and other aspects of the invention will be apparent from and elucidated with reference to the embodiments described hereinafter.

The method, apparatus and system in accordance with the above described aspects of the invention have a number of advantages with respect to prior art, as for example:
Non-invasive, more simple, less resources: It does not require the user to wear specific sensors or interacting with device in unnatural ways, such as keeping the front camera pointing at one's face.
It allows privacy-preserving implementation: While the proposed system may use potentially sensitive input, such as a person's location, it allows processing such information on a trusted and personal device, such as the person's mobile phone, or a service that has been trusted with processing location information. Only the prediction, which can be as little as “likely to be pay attention/not likely to pay attention” or “likely to be receptive to content/not likely to be receptive to content” or “likely to be bored/not likely to be bored” needs to be communicate to external services that built on top of this invention.
High availability: As user's communications device such as mobile phones, are oftentimes carried throughout the whole day, the prediction may work throughout large parts of the day. Thus, the approach maximizes the coverage and the ability to detect phases of boredom.
It enables the design of intelligent services that would leverage the state of the user to decide when to engage with him/her and how.
It increases conversion rate of suggested content, saving communication resources: This is shown by evidence from an experiment, users are more likely to engage with suggested content when predicted to be bored. In our studies, people were 2.56 times more likely to open and 3.75 times more likely to engage for longer time with suggested content. For the company providing the content, the conversion rate will increase for each individual message, so less messages need to be sent, saving communications resources and costs.

These and other advantages will be apparent in the light of the detailed description of the invention.

### DESCRIPTION OF THE DRAWINGS

For the purpose of aiding the understanding of the characteristics of the invention, according to a preferred practical embodiment thereof and in order to complement this description, the following figures are attached as an integral part thereof, having an illustrative and non-limiting character:

FIG. 1 shows a schematic block diagram of a system according to an embodiment of the present invention.

FIG. 2 shows a block data flow of a possible use case according to an embodiment of the invention.

### PREFERRED EMBODIMENT OF THE INVENTION

The matters defined in this detailed description are provided to assist in a comprehensive understanding of the invention. Accordingly, those of ordinary skill in the art will recognize that variation changes and modifications of the embodiments described herein can be made without departing from the scope of the invention. Also, description of well-known functions and elements are omitted for clarity and conciseness.

Note that in this text, the term “comprises” and its derivations (such as “comprising”, etc.) should not be understood in an excluding sense, that is, these terms should not be interpreted as excluding the possibility that what is described and defined may include further elements, steps, etc.

Of course, the embodiments of the invention can be implemented in a variety of architectural platforms, operating and server systems, devices, systems, or applications. Any particular architectural layout or implementation presented herein is provided for purposes of illustration and comprehension only and is not intended to limit aspects of the invention.

The present invention proposes a method, apparatus and system for determining the level of attention (also called receptivity level) of users of a communications device in a variety of situations without requiring the use of additional sensors or performing extra activities. This way, situations when the users are more receptive to content presented to them (through the same communications device or using other communications device) are detected. In order to do so, the present invention uses a user-independent computer based predicting and learning technique (for example a machine-learning model), leveraging features related for example to recency of communications, usage intensity, time of day . . . among others. External services may be triggered when it is detected that the user is likely to be more receptive to content, allowing the services to be customized according to their potential users' level of attention and need for stimulation.

The proposed method and system take advantage of the fact that people carry their communications device (e.g. mobile phones) on a regular basis (which can serve as passive measuring device of the user's context) and that when people face phases of boredom and lack of stimulation (so their attention level to presented content is high), they very often turn to their mobile phones for relief. The users' communications device may be any user electronic communication device as for example a laptop, a tablet, a personal computer, a portable computer, a mobile phone, a smart phone or any communications receiver.

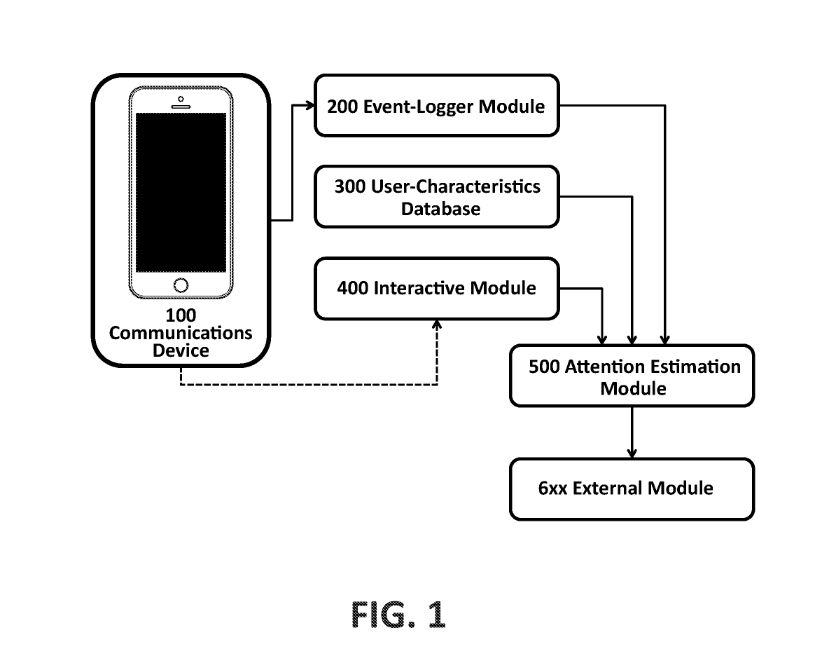

FIG. 1 presents a block diagram of the proposed system according to an embodiment of the present invention. The different elements or functions of the systems are shown in different isolated blocks, but this is only for clarity purposes. Actually, some of the different functions shown in FIG. 1 can be executed in the same block and/or in the same device (for example, the blocks may be within the user communications device even it is shown as separate blocks). In FIG. 1, some communications interfaces between the different components are shown (with arrows) but this is only for clarity purposes and it is not an exhaustive list of all communications between the different modules.

As stated before, this system infers (estimates) attention level (or in other words receptivity to new contents presented to the users) of the users (e.g. boredom) from input that reflects behave patterns of the user and it may comprise the following elements (not all the following listed elements are mandatory, that is, there may be embodiments of the method, apparatus and system proposed by the present invention which do not comprise some of this elements):
A user's communications device (100) (in the case of FIG. 1 a mobile phone also called mobile device) carried by the user. The communications device is connected to at least one communications network (a wireless communications network, a mobile communications network as GSM 2G, GPRS, UMTS, 3G, 4G or LTE, LAN or W-LAN or any other type of communication networks) which allow the user to communicate with other users or to access to certain services provided by different service providers.
An event-logger module (200): This functional block gathers different data of the communications device (in the case of FIG. 1, of the mobile phone), especially data related to the usage of the communications device and usage context. Generally speaking, this module collects mobile phone's events (any state change in the mobile phone), especially user's interactions with the mobile phone (generally speaking, any user's interaction with the user's communications device), such as unlocking the phone, receiving or sending a phone call or a message, accessing to the web browser to access to internet, opening/closing an application . . . . This interaction between the user and the communications device may be done through an user interface of the communications device (display, keys . . . ). This block also may create statistics (usage statistics) on how the user interacted with the mobile phone in a specified time window (e.g. in the last 5 minutes) as well as the context of the time window (e.g. the hour of the day).

Examples of inputs recorded into the event-logger module (100) are contextual factors (e.g., hour of the day, day of the week, location, . . . ), usage patterns related to communication (e.g., time since last phone call, SMS, message, . . . ), known affect (e.g., previous attention level/boredom rating), usage intensity (e.g., battery drain, bytes transmitted via mobile network), externally prompted usage (e.g., number of notifications in time window), usage indicating idling/wasting time (e.g., number of unlocks in time window, number of apps opened in time window, . . . ) or type of usage (e.g., category of most used app, time spent in communication apps, . . . ). Of course this is a non-exhaustive list and this module may have other inputs.
A user-characteristics database (300) containing user information or more generally speaking information of the user's profile. This information can be demographic data and other stable information on the user, such as age or gender, and optionally psychological traits of the user (such as her/his proneness to boredom, the big-5 psychological traits), estimations of user physical activity, etc.
An interactive module (400). The system may include this module to collect ground truth data (e.g. the real level of attention) of the user. In other words, this module facilitates means to identify the ground truth, that is, the real attention (e.g. boredom) level of the user (e.g. whether the user is bored or not) in certain situations. In a preferred embodiment, this is done via experience sampling, that is, presenting the user with short questionnaires on the current attention level (e.g. level of boredom) at different times throughout the day. This module is used to establish, re-confirm, adapt or personalize the estimation (prediction) of attention level.
An attention estimation module (500) (also called receptivity estimation or prediction module, attention prediction module or boredom prediction module). In this functional block the user's attention level (e.g. the level of boredom) is predicted, fusing the available data from usage statistics (200) and optionally from user characteristics (300) and data from the interactive module (400) if any. In order to do so, any (computer based) technique can be used to compute and predict the user's attention level; in other words any computer-based technique to compute and predict the attention levels could be used (e.g. matching usage data and user's data with levels of attention). For example, this block may use a machine-learning model of boredom-related behavior which is trained with the available data. In other words, the data collected in the event-logger module (200), optionally the data stored in the user-characteristic database (300) and, if any, the interactive module (400) are used as input in the estimation module (500) to train and update a model that matches statistics of recent phone usage events and user characteristics with attention (receptivity) levels. In an embodiment, the model is created by supervised machine-learning classification algorithms, such as Bayesian Networks, Linear Regression, Support Vector Machines, Decision Trees (e.g. C4.5, Random Forests, . . . ), Hidden Markov Models or any other known algorithm. In order to improve the performance of the prediction, the module may employ standard methods (e.g. Information Gain, Correlation, or Subset Selection) to determine how predictive of the user's attention level (e.g. level of boredom) the individual inputs are. This is used to—if applicable—reduce the number of inputs to improve the performance of the module. In an embodiment, this classification is binary, that is, the user is either classified as receptive or not receptive (bored or not bored).

Sometimes, it is more interesting to take more into account the events (e.g. user's interactions with the mobile device) currently happening than previous events, in order to have a more updated and real measurement of the current user's attitude. This can be made in several ways, for example, giving a higher weight to the currents events than to previous events when making the estimation, using the estimation from previous events and moving the user's receptivity level according to the current events.
The system may also comprise a communications module to trigger (notify) one or several external modules (6xx) (for example, external service providers) when the user is estimated to have a certain level of attention. That is, when the user is estimated to have a certain level of attention, the apparatus sends, using a communications network, a notification (or more generally speaking an indication, a message or a signal) optionally including some information about the estimated attention level, directly or indirectly to one or more external modules (generally speaking “n” external modules) to tell them that the user is estimated to have a certain level of attention, triggering a certain service to be provided to the user (for example, sending a certain content to the user). In an embodiment, the communications module informs (for example periodically) of the attention level estimated by the estimation module to one or several external modules and according to said estimated attention level, they decide whether to provide a certain service to the user or not.

In an embodiment, said external modules (6xx) are also part of the apparatus.

Depending on the embodiment, these modules are in the same or in different physical places (different devices). In the preferred embodiment, all modules and possible also the external modules, reside on the mobile phone (this allows the most detailed access to usage events). In other embodiments, the modules (except the mobile device itself) are residing on one or more servers that facilitate services to the mobile phone, such as connectivity providers. In other embodiments, some modules may be in the mobile device (for example the mobile device, the event-logger module and the user characteristics database) and the rest in one or more servers (connected by a communications network with the mobile device). In the case that the modules are in a server, the communications device communicates with the server through a communication networks (a wireless communications network, a mobile communications network as 2G, 3G, 4G or LTE, LAN or W-LAN or any other type of communication networks . . . ).

The data collected by the event-logger module (200) may comprise (but not limited) one or more of the following features (events). Of course, this is only an example, and in other embodiments other type of information can be collected. In the following tables, the data has been classified in different categories depending on the type of information contained in the features. Some of these features may not have a direct relationship with attention (e.g. boredom) level, but may become indicative when combined with other features

| | Context: Features to estimate the context |
|---|---|
| | (situation) of the user, since attention |
| Name | level might depend on the context |
| audio | Indicates whether the phone is connected |
| | to a headphone or a bluetooth speaker |
| charging | Whether the phone is connected to a charger |
| | or not |
| day_of_week | Day of the week (0-6) |
| hour_of_day | Hour of the day (0-23) |
| is_at_home | Flag whether user is at home |
| light | Light level in lux measured by the proximity |
| | sensor |
| proximity | Flag whether screen is covered or not |
| ringer_mode | Ringer mode (silent, vibrate, normal) |
| semantic_location | Whether the user is at home, at work, or |
| | elsewhere |
| is_at_work | Flag whether user is at work |

| | Last activity: The time since the last |
|---|---|
| | activity might indicate how engaged the |
| Name | user is with the phone |
| time_last_incoming_call | Time since last incoming phone call |
| time_last_notif | Time since last notification (excluding |
| | Borapp probe) |
| time_last_outgoing_call | Time since the user last made a phone call |
| time_last_SMS_read | Time since the last SMS was read |
| time_last_SMS_received | Time since the last SMS was received |
| time_last_SMS_sent | Time since the last SMS was sent |

| | Usage-Intensity: Features indicating the |
|---|---|
| | intensity of phone usage in a certain |
| Name | previous time period (time window) |
| battery_drain | Average battery drain in time window |
| battery_level | Battery change during the last session |
| bytes_received | Number of bytes received during time window |
| bytes_transmitted | Number of bytes transmitted during time window |

| | Usage-external: Features indicating usage |
|---|---|
| | that was triggered externally - which might |
| | be an indicator for receiving sufficient |
| Name | stimuli |
| num_notifs | Number of notifications received in time |
| | window |
| num_comm_notifs | Num. of notifs. from communication apps in time |
| | window |
| last_notif | Name of the app that created the last |
| | notification |
| last_notif_category | Category of the app that created the last |
| | notification |

| | Usage_idling: Features indicating whether the |
|---|---|
| | user is idle, i.e. just clicking back of forth |
| Name | looking for stimulus |
| apps_per_min | Number of apps used in time-window divided |
| | by time the screen was on |
| num_apps | Number of apps launched in time window |
| | before probe |
| num_unlock | Number of phone unlocks in time window |
| | prior to probe |
| time_last_notif_access | Time since the user last opened the notifi- |
| | cation center |
| time_last_unlock | Time since the user last unlocked the phone |

| | Usage Type: Features indicating what the |
|---|---|
| Name | phone is used for |
| screen_orient_changes | Number of changes between landscape and |
| | portrait mode |
| app_category_in_focus | Most used app category in time-window |
| app_in_focus | App that was in focus prior to the |
| | probe |
| most_used_app | Name of the app most used in the time |
| | window |
| most_used_app_category | Category of the app most used in the time |
| | window |
| prev_app_in_focus | Previous app in focus prior to probe |
| time_in_comm_apps | Time spend in communication apps in time |
| | window |
| comm_in_focus | Flag whether the most-used app in time |
| | window is Communication |

The data collected by the user-characteristics database (300) may comprise (but not limited) one or more of the following features (events). Of course, this is only an example, and in other embodiments other type of data can be collected.

| | Demographics: As boredom and more generally speaking, |
|---|---|
| Name | attention level, might vary between age groups and gender |
| age | The user's age in years |
| gender | The user's gender |

| | Previous affect: Since affect (attention |
|---|---|
| | level) might be stable, it might make |
| Name | sense to include previous affect |
| ground_truth_last_esm | Ground truth (bored, not bored) from |
| | previous rating |

| | Personality traits: Stable personality traits |
|---|---|
| | which can for example be established by |
| Name | validated questionnaires |
| boredom_proneness | Proneness to boredom |
| big_five | Big Five personality traits, including |
| | openness to experience, conscientiousness, |
| | extraversion, agreeableness and neuroticism |

Feasibility studies show that models built using the above mentioned features (excluding previous affect and personality traits), achieve an accuracy of 82.9% AUCROC. AUCROC stands for area under the ROC (Receiver Operating Characteristic) curve and is typically used to replace the standard classification accuracy metric for unbalanced datasets. As each classifier, the model can be tuned to balance precision, in this case, (being sure that the person has a high receptivity to inputs, e.g. he is bored) and recall (not missing instances when the person has a high receptivity to inputs). Typically, precision decreases when aiming at increasing recall and vice versa. To give two examples of the performance of the model from the perspective of precision and recall: the model achieves a precision level of 70.1% for 30% recall, and 62.4% for 50% recall for predicting whether the person is bored.

From the data collected from other modules, the attention prediction module (500) estimates the user's attention level (e.g. the level of boredom). In order to do this, this module may take into account the following high-level aspects (derived from the collected data) which, according to feasibility studies, are most indicative of attention level (e.g. boredom):
Recency of communication activity expressed by the features regarding the last time that the user communicated via phone, WhatsApp, SMS, facebook . . . and the last time since notifications arrived, as notifications where largely generated by applications from the communication category. Users tended to be more bored (so more receptive to incoming content) the more time had passed since receiving calls, SMS, or notifications, and the less time had passed since initiating communication (via calls, SMS, WhatsApp . . . ). However, the volume of notifications received in the last 5 minutes was likely to be higher when being bored.
Intensity of recent usage reflected by features such as the volume of internet traffic, # phone unlocks, and level of interaction with applications in the last five minutes. While the last unlock was more recent when being bored, there were fewer unlocks in the last 5 minutes. Similarly, while the data upload is higher when people are bored, the data download is lower.
General usage intensity captured by e.g. battery drain, state of the proximity sensor (i.e., whether the phone's screen is covered), or time since last phone use. The screen is less likely to be covered (which, for example, happens when the phone is stowed away), more apps are used, the last unlocking and checking for new notifications happen more recently, the battery drain was higher, and the volume of data uploaded is higher when people are bored.
Context/time of the day reflected by the hour of the day and/or for example the values of the light sensor. Boredom is more likely the later it was in the day and the darker the ambient lighting conditions.
Demographics, i.e. the participants' gender and age. Male participants tended to be more bored, and boredom was higher for participants in their 20s and 40s and lower in their 30 s.

Finally, there are some mobile phone applications which are most strongly correlated with being bored (i.e. said applications are more used when the user is bored). Some of these applications are Instagram, e-mail, built-in browser, settings . . . . On the contrary there are some mobile phone applications which are most strongly correlated with not being bored (i.e. said applications are more used when the user is not bored) as for example, communications applications, SMS, Google Chrome . . . . So the applications used by the user in previous time intervals and the time he has been using said applications, may be also used to estimate his level of boredom.

In some embodiments of the invention (called network-event-based implementation), the system would use data as it is passively captured by the network infrastructure (e.g. mobile network infrastructure), as available to telecommunication providers, as main input. The above stated modules 200, 300 400, 500 and maybe some external modules (6xx) would run on a server that has access details of the mobile device and its users. Said access details (collected features) may be recorded for billing purposes by telephone and internet providers, and may be for example, among others:
Call data records: Last time since incoming and outgoing phone calls and since last incoming and outgoing SMS, WhatsApp messages . . . .
Network events: Amount of data received and transferred via mobile network
Semantic Location: Whether the user is likely to be at home, at work, or at another (unspecified) place
Demographic data: age and gender
Personality data derived from typical call behavior

In the preferred embodiment, the system runs an interactive module (400) (for example on the mobile device of the user), which allows to establish the (quantified) ground truth for the computer based algorithm (e.g. a machine learning algorithm) used by the attention estimation module (500). The ground truth may be established via e.g. experience sampling that is, regularly asking the user to rate her or his current attention level or level of boredom (i.e. user is probed at certain times throughout the day to collect his feedback about his current attention levels), through an user interface of the communication device. These probes can be scheduled in regular intervals (e.g. 60 minutes). There are some users which always rate themselves to be much more bored on average than the rest (they have different predisposition to boredom). To take this effect into account, for this type of user, instead of measuring his absolute level of boredom (as rated by him during the probes), it is measured when they feel more or less bored than on average during the previous probes made to this user.

In another embodiment, the ground truth (the real attention level of the user) could be established by success-rate of the engagement attempts. One instance of an external module (6xx) tries to engage the user to conduct a measurable activity, such as clicking on a link, watching a video, or reading an article or any other. This module records if—and, if applicable, for how long—the user interacts with the content and feeds this back into the interactive module (400). This way, the user's level of boredom is not established by the user's subjective feedback, but by an objective measure.

In an embodiment, the attention estimation module (500) conducts a binary decision: whether the user is likely to be bored/killing time/receptive to content (high level of attention), or not (low level of attention). In another embodiment, the level of attention is modeled in a more fine-grained way. For example, when using the default embodiment of the interactive module (400) to collect ground truth data, i.e., the level of boredom of the user, the responses may also be collected in a numerical way. For example, the user may be asked to indicate, to what extent on a 5-point scale she or he agrees with the question “Right now, I am killing time on my phone.” The results of these scale may be used directly as ground truth, and used in a multi-class prediction model or may serve as numerical input, e.g., for a Linear Regression model. As stated before, in another embodiment, the interactive module (400) may take measurable behavior as indicator for the level of boredom. Example measures include for example: the time between the recommendation of content by an external module and the user accessing this content, or the time that the user spent interacting with recommended content.

Another embodiment takes contextual information into account to assess a probability for the user to be bored in such a context. For example, if a user is detected to be in a waiting situation, or of the user keeps browsing services that are known to be designed to kill boredom, this is taken as examples of situations where the user is likely to be bored. Phone-usage patterns observed in these situations would then be indicative of the user being killing time in general.

Now, some possible use cases, for the present invention, are going to be listed. Of course, this is only a non exhaustive example list, and the proposed invention may be used for many other applications/use cases.

Smart Notification timing: One embodiment of application of the invention is to enable a smart timing for delivering push notifications, that is, scheduling notifications from services provided to the user, depending on the estimated user's level of attention. In one embodiment, this is used to restrict non-important notifications to times when the receiver is estimated to be receptive to notifications (the attention level). Examples for such non-important notifications are: the availability of software update, announcement of new features in the software, announcing the availability of a new recommendation, etc.

Sharing as an Indicator of Availability: Sometimes, special circumstances require that the user is contacted (e.g. by a service provider). People or companies might have the desire or the need to get in touch with a person, but they wish to keep the possibility of interrupting the person at an unsuitable moment, at a minimum. For example, the gas provider might want to call to make an appointment for the annual revision of the heater. If the attention level (level of receptivity) estimation is shared with them, they can use the prediction to time their moment of getting in contact with the person. The assumption is that if a person is predicted to be receptive to content, a contact attempt will be less likely to fail or annoy the person.

Push-based Advertisement: One advertisement channel that internet-connected end-user communications devices have enabled is—with the proper permissions/consent—to proactively push offers, promotions, and advertisements directly to their users. Doing advertisement campaigns via such channels, e.g. sending special offers via SMS, could tremendously benefit from suppressing messages when the user is not receptive to new contents (he is not bored). The advantage for the receiver is that advertisement messages are less likely to arrive in situations where they are interrupting, stressing, or annoying the user so the advertisement is better received by the user. For the advertisement company, the advantage is that the conversion rate will increase for each individual message (because they are sent when the user is more receptive to new content), so less messages need to be sent (saving communications resources and costs). Studies confirm that the receptivity estimation (e.g. boredom estimation) makes a significant different: people are significantly more likely to read an entertaining news web page when bored. The effect size of the estimation (prediction) is large (r>0.500; where r is the Pearson's correlation coefficient which is widely used as an effect size when paired quantitative data are available. It can vary in magnitude from −1 to 1, with −1 indicating a perfect negative linear relation, 1 indicating a perfect positive linear relation, and 0 indicating no linear relation between two variables). This means that statistically speaking, the prediction accounts for a large part of the observed variance. In other words, while many factors influence whether people interact with suggested content, boredom is one of the strong factors.

In order to do that, there may be a message scheduler which receives a request to send certain content (e.g. advertisement message) to an specific user's communication device (usually with information about the address of the device). Said request is received for an advertising company or any other type of service provider or communications entity. The message scheduler also receives from the attention estimation module of the present invention, an estimation of the receptivity level of said specific user. The message scheduler sends a message including the requested content to the user's communication device when the estimation of the receptivity level of said specific user indicates that the receptivity level of said user is high. Said message scheduler is called intelligent message scheduler as it schedules the sending of a message to the user when the user is more receptive to said message.

In an specific embodiment, the system proposed by the present invention, will send information about the attention (receptivity) level of a user to an external module (server) belonging to an advertisement infrastructure. According to said information:
The advertisement infrastructure may, for example, act as a “selective advertisement blocker”, that is, it won't serve any advertisement to the user unless the user has a minimum level of attention (in other words, it only will send an advertisement to the user when the estimated attention level for said user is above a certain threshold).
The advertisement infrastructure may make the estimated level of attention part of the bidding process of the advertisers. That is, it will charge higher prices to advertisers if they want their advertisement content to be sent to the user when the estimated attention level for said user is high (moments in which the user is more likely to pay attention to their content).—

Boredom as a trigger for mindfulness: The emotional state of boredom is connected to creativity and to a healthy mental condition. Therefore, an automatic system that is able to detect when the user is bored would be valuable to design technology that encourages people to embrace boredom as a state for introspection, mind wandering and/or mindfulness. In an embodiment of this invention, the inferred states of boredom would be used to trigger an intelligent user interface that would suggest the user to practice mindfulness.

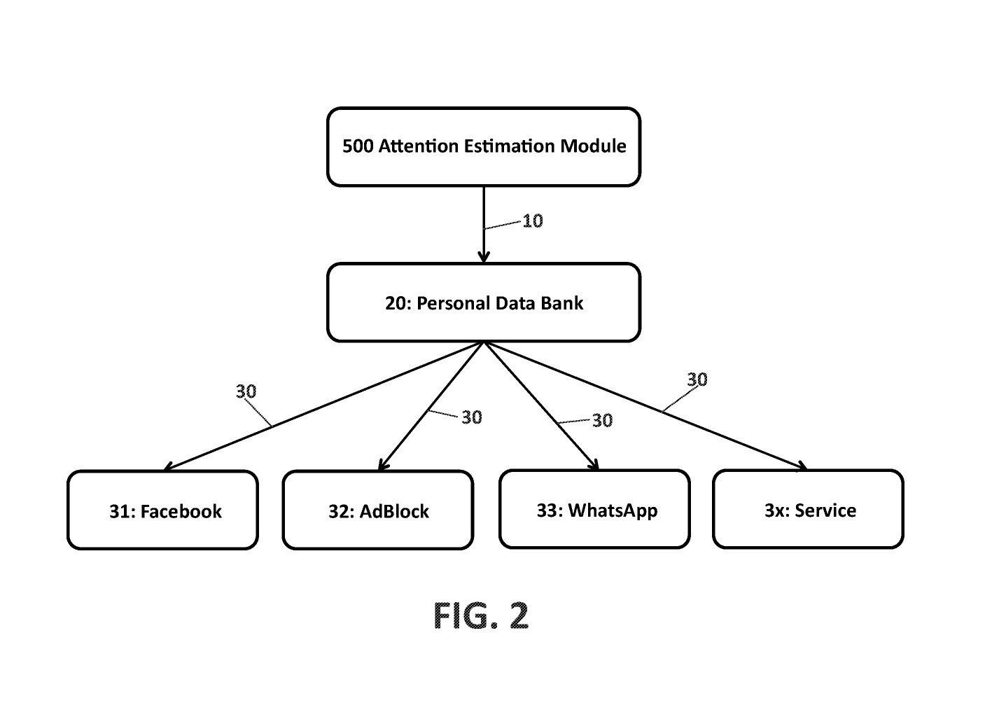

Receptivity as a Contextual Variable shared with Services: Recently, the idea is getting traction that people should own the data they generate. This idea may be implemented, for example, through a Personal Data Bank where the data is stored and managed by the user, such that the user retains full control over how the data is shared with third parties. This can, for example, be a dedicated cloud service hosted by a company or a system running locally, e.g. on a mobile device. FIG. 2 shows a block data flow of this use case. The inferred receptivity (boredom) state of the user, obtained by the receptivity estimation module (500) (that may be located in the user's communications device or in a server which collects information of the user's communication behavior) could be fed (10) and stored in the user's personal databank (20) as another piece of relevant personal information.

This inference (estimation) of the user's state of boredom could then be used to improve the experience of external services, by the personal data bank (20) sharing (30) the user's inferred boredom state with these services (that is, the personal databank forwards the prediction to different services providers). For example, many services on the web and on mobile devices finance themselves by showing advertisements. Examples are advertisements shown next to search results, in timelines of social networks, on in banners of websites and mobile applications. Sharing the user's inferred boredom state with these services could make advertisements less obtrusive and more effective. For example, websites such as Facebook (31) could reduce the number of ads shown when the user is not bored. Ad-blocking tools like AdBlock (32) could use the prediction for only blocking advertisement selectively, e.g. when the user is not bored, which would prevent services to be cut off from the funding they depend on. In the context of messengers (e.g. WhatsApp 33), the application could share the predicted state amongst (favorite) contacts. This could e.g. help when a messenger use decides whether to write a friend or make a call. Of course, this information may be provided by the personal databank to any other types (3×) of services which might be provided to the user.

Further, the estimations of the user's receptivity state (state of boredom) may be stored in a database (in the user's communication device or in any other node) and retrieved for later analysis. For example, owners who are interested in the concept of Quantified Self (a movement to incorporate technology into data acquisition on aspects of a person's daily life in terms of inputs (e.g. food consumed, quality of surrounding air), states (e.g. mood) and performance could use the history of inferred boredom states over time to learn about themselves (called Quantified Self visualization). In other use cases, these estimations could be used to characterize the user's patterns of boredom throughout the day. These patterns of boredom could then be used in similar fashions as above, e.g. to selectively block/allow advertisements or to suggest good time intervals to contact people.

Even in many of the embodiments disclosed in the present text, the user's communication device is a mobile phone; the present invention can be also applied to any other user electronic communication devices as for example laptops, tablets, personal computers or portable computers for example.

In this text, the expression user activities, user actions or user interactions with the communications device is used to refer to the same concept, that is, the actions between the user and the communications device. That is, actions that the user performs in order to interact with (use) the communications device or any action that the communications device perform to trigger an action of the user (e.g. notifying in the display of the communications device an incoming message).

Although the present invention has been described with reference to specific embodiments, it should be understood by those skilled in the art that the foregoing and various other changes, omissions and additions in the form and detail thereof may be made therein without departing from the scope of the invention as defined by the following claims.

1. A method for monitoring attention level of a user of a communications device, the method comprising the following steps:
an electronic device obtaining information about the communications device usage by the user and usage context;
the electronic device determining, using a computer based technique, the attention level of the user based at least on obtained information about the communications device usage and usage context;
if the electronic device determines that the attention level of the user is above a certain threshold, the electronic device transmitting through a communications network a notification.

2. The method of claim 1 where the attention level of the user is determined based as well on user profile information obtained by the electronic device.

3. The method of claim 2 where said user profile information is at least one or more of the following: user's demographical information, user's personality traits or user's physical activity.

4. The method of claim 1, further comprising: the electronic device transmitting through the communications network, the determined attention level to one or more external service providers.

5. The method of claim 1, where the notification is sent to at least one external service provider and said notification triggers that the external service provider provides a certain service to the user through an user's communications device.

6. The method of claim 1 where the electronic device is part of the communications device.

7. The method of claim 1 where the electronic device is a server, the communications device being communicated with the server through the communications network.

8. The method of claim 1 where the method further comprises:
the electronic device obtaining ground-truth information about previous attention level of the user and where the attention level of the user is determined based as well on the obtained ground-truth information.

9. The method of claim 8, where the determining step includes:
using a computer based model of the level of attention of the user for determining the level of attention, based at least on obtained information about communications device usage and about usage context;
wherein the model has been trained and updated using obtained ground truth information and/or previous information about of the communications device usage.

10. The method of claim 8, where the ground truth information is obtained:
by sending periodically a message to the communications device of the user, through a communications network, asking to the user about his attention level or
by transmitting through the communications network, media content to the user and recording whether the user interacts with the content or not; or by measuring the time between the recommendation of a media content to the user and the user accessing this media content; or by measuring the time that the user spent interacting with recommended media content.

11. The method of claim 1 where the notification is sent to an external service provider, the external service provider being an advertisement service provider, where the notification includes information about the determined attention level of the user and where the method further includes:
the advertisement service provider sending advertisement content to the communications device of the user depending on the determined attention level of the user received and/or
the advertisement service provider charging to the advertised companies for sending his advertisement content to the communications device of the user when the determined attention level of the user is higher than a certain minimum level.

12. The method of claim 1 where the information about the communications device usage includes one or more of the following type of information: usage patterns of the communications device by the user, previous attention level, recent usage intensity of the communications device, number of notifications to the user trough the communications device in a time window, number of unlocks of the communications device in the time window, data throughput within the time window, last application used by the user in the time window, number of applications opened by the user in the communications device in the time window, category of most used applications app in the communications device by the user or time spent in communication applications by the user in the communications device.

13. The method of claim 1 where the information about the communications device usage is recorded for billing purposes by a communications provider and said information includes at least one of the following information: Call data records, Network events, Location, Demographic data of the user and Personality data derived from typical call behavior

14. An electronic device for monitoring attention level of a user of a communications device, the electronic device comprising:
an event-logger module for obtaining information about the communications device usage by the user and usage context;
an estimation module for determining, using a computer based technique, the attention level of the user based at least on the information obtained by the event-logger module about the communications device usage and usage context;
a communications module for transmitting through a communications network a notification, if it is determined that the attention level of the user is above a certain threshold.

15. The electronic device of claim 14, further comprising:
an user characteristic database storing user profile information and where the attention level of the user is determined by the estimation module based as well on the user profile information stored by the user characteristic database and/or
an interactive module for obtaining ground-truth information about previous attention level of the user and where the attention level of the user is determined by the estimation module based as well on ground-truth information obtained by the interactive module.

16. The electronic device of claim 14, further comprising:
the communications module transmitting through the communications network, the determined attention level to one or more external service providers.

17. The electronic device of claim 14, where the electronic device is part of the communications device and the communications device is a mobile phone.

18. The electronic device of claim 14, where the electronic device is a network server.

19. A system for monitoring attention level of a user of a communications device, the electronic device comprising:
the communications device of the user for providing communications service to the user through a communications network.
an electronic device according to claim 14, the electronic device comprising:
an event-logger module for obtaining information about the communications device usage and usage context;
an estimation module for determining, using a computer based technique, the attention level of the user based at least on the information obtained by the event-logger module;
a communications module for transmitting through a communications network a notification, if it is determined that the attention level of the user is above a certain threshold.

20. A non-transitory computer readable medium, comprising instructions for causing a computer device to perform the method of claim 1.
